(19) United States
(12) Patent Application Publication
(10) Pub. No.: US 2009/0159649 A1
(43) Pub. Date: Jun. 25, 2009

(54) Soldering method

(76) Inventor: Yasushi Inoue, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/316,106

(22) Filed: Dec. 8, 2008

(30) Foreign Application Priority Data
Dec. 21, 2007 (JP) 2007-330401

(51) Int. Cl. B23K 31/02

(52) U.S. Cl. 228/234.1

(57) ABSTRACT

Embodiments of the present invention provide a soldering method capable of satisfactorily melting a solder without damaging a workpiece be soldered. One embodiment of a soldering method removes component waves of predetermined wavelengths from a light beam emitted by a light source and melts a solder by irradiating the solder with a light beam obtained by removing the component waves of the predetermined wavelengths from the light beam emitted by the light source.

### CROSS-REFERENCE TO RELATED APPLICATION

The instant nonprovisional patent application claims priority to U.S. Provisional Patent Application No. 2007-330401, filed Dec. 21, 2007 and which is incorporated by reference in its entirety herein for all purposes.

### BACKGROUND OF THE INVENTION

Soldering methods that melt a solder by irradiating the solder with light are disclosed, for example, in JP-A H5-245623 (“Patent document 1”) and JP-A H7-142853 (“Patent document 2”). Such a method focuses light having a predetermined wavelength spectrum emitted by a light source, such as a xenon lamp, by a lens or the like on a solder. Thus the solder can be melted to bond electronic parts or the like without bringing a soldering device into contact with the solder.

When a part, such as a flexible cable having, for example a coating of a polyimide, is soldered, it is possible that the part is burned by heat if the part is irradiated with light of an excessively high intensity emitted by a light source. If light of a low intensity is used to avoid damaging the part, it is strongly possible that the solder cannot be satisfactorily melted, faulty soldering results and repair work is needed. In some cases, it is difficult to melt the solder satisfactorily without damaging a workpiece only by adjusting the intensity of light.

### BRIEF SUMMARY OF THE INVENTION

Embodiments of the present invention provide a soldering method capable of satisfactorily melting a solder without damaging a workpiece be soldered. One embodiment of a soldering method removes component waves of predetennined wavelengths from a light beam emitted by a light source and melts a solder by irradiating the solder with a light beam obtained by removing the component waves of the predetermined wavelengths from the light beam emitted by the light source.

### BRIEF DESCRIPTION OF THE DRAWINGS

FIG. 1 is a view of a workpiece to be soldered by a soldering method in an embodiment according to the present invention.

FIG. 2 is a schematic view of a soldering device for carrying out the soldering method in an embodiment.

FIG. 3 is a graph showing a spectrum of light emitted by a light source.

FIG. 4 is a view showing the construction of a filter by way of example.

FIG. 5 is a fragmentary, enlarged view showing another construction of a filter.

FIG. 6 is a fragmentary, enlarged view showing third construction of a filter.

FIG. 7 is a view showing soldering devices in different arrangements.

### DETAILED DESCRIPTION OF THE INVENTION

Embodiments of the present invention relate to a soldering method that melts a solder with light emitted by a light source.

Embodiments of the present invention have been made in view of the foregoing problem and it is an object of embodiments of the invention to provide a soldering method capable of satisfactorily melting a solder without damaging a workpiece to be soldered.

A soldering method according to an embodiment of the present invention, comprises, removing component waves of predetermined wavelengths of a light beam emitted by a light source; and melting a solder by irradiating the solder with a light beam obtained by removing the component waves of the predetermined wavelengths from the light beam emitted by the light source.

In the foregoing soldering method, the component waves of the predetermined wavelengths are those that are absorbed by a workpiece at an absorptance higher than that at which the workpiece absorbs component waves of wavelengths other than those of the predetermined wavelengths.

In the foregoing soldering method, the predetermined wavelengths are those longer than a predetermined threshold.

In the foregoing soldering method, the step of removing component waves of the predetermined wavelengths uses a metal filter provided with apertures of a size corresponding to a predetermined threshold to remove the component waves of the predetermined wavelengths from the light emitted by the light source.

According to embodiments of the present invention, the solder can be satisfactorily melted without damaging the workpiece by irradiating the solder with the light from which component waves of the predetermined wavelengths have been removed.

A soldering method in an embodiment according to the present invention will be described with reference to the accompanying drawings. In the following description, it is suppose that a part (workpiece) to be subjected to soldering by the soldering method in this embodiment is a flexible cable coated with a coating of a polyimide or the like and the flexible cable is connected to a metal terminal.

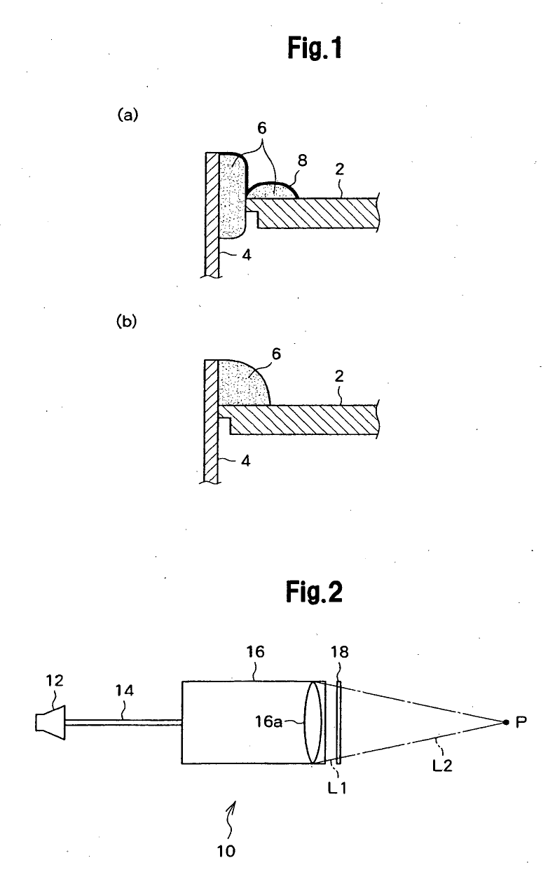

FIGS. 1(a) and 1(b) are sectional views of a flexible cable 2, namely, a workpiece, and a metal terminal 4 to which the flexible cable 2 is soldered. FIG. 1(a) shows a state in which a solder 6 attached to the flexible cable 2 and the metal terminal 4 is coated with flux 8. This embodiment irradiates the solder 6 in the state shown in FIG. 1(a) with a light beam to heat and melt the solder 6 for soldering. FIG. 1(b) shows a state in which the flexible cable 2 has been bonded to the metal terminal 4 by melting the solder by soldering.

FIG. 2 is a typical view of a soldering device 10 employed in carrying out the soldering method in an embodiment. The soldering device 10 includes a light source 12, an optical fiber 14, a lens unit 16 and a filter 18. The component waves of the soldering device 10 will be described.

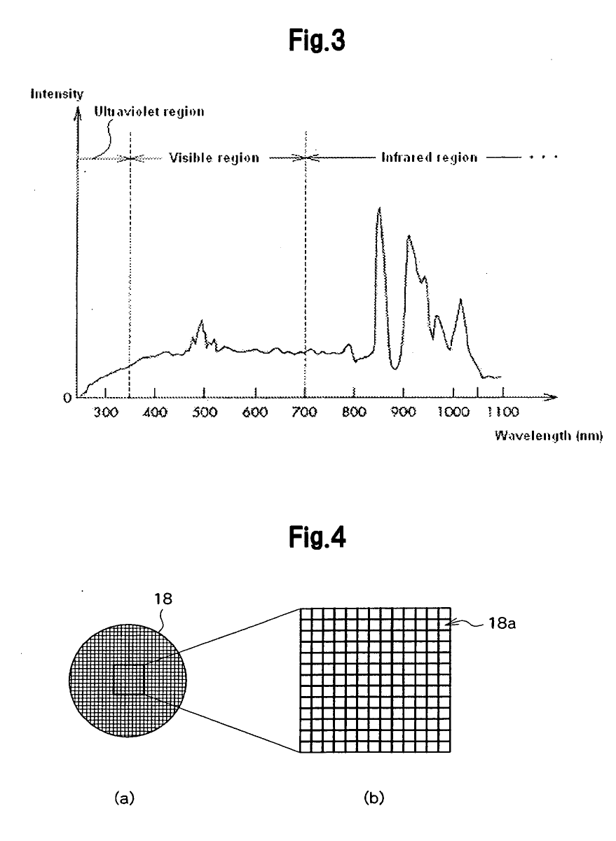

The light source 12 is a xenon lamp or the like. The light source 12 emits a light beam L1 having a continuous spectrum. FIG. 3 is a graph showing the spectrum of the light beam L1 by way of example. In the graph shown in FIG. 3, wavelength is measured on the horizontal axis and intensity is measured on the vertical axis. In the light beam L1 shown in FIG. 3, component waves of wavelengths in the infrared region of about 700 nm or above have high intensities as compared with those of the component waves of in the visible region between about 350 nm and about 700 nm and the ultraviolet region of about 350 nm or below.

The light beam L1 emitted by the light source 12 is transmitted by the optical fiber 14 and falls on the lens unit 16. The lens unit 16 is an optical system including a condenser lens 16a. The condenser lens 16a focuses the light beam L1 traveled through the optical fiber 14 on the focal point P of the condenser lens 16a. The lens unit 16 is positioned such that the solder 6 is in the vicinity of the focal point P to irradiate the solder 6 with the light emitted by the light source 12.

The filter 18 is an optical device that absorbs component waves of predetermined wavelengths of the incident light beam L1 and transmits component waves of lengths other than the predetermined wavelengths. In a case shown in FIG. 1, the filter 18 is disposed between the lens unit 16 and the focal point P, where the solder 6 is positioned. Thus the waves of the predetermined wavelengths are removed from the light to be projected on the solder 6. In the following description, light provided by removing the component waves of the predetermined wavelengths by the filter 18 will be called a transmitted light beam L2. Use of the transmitted light beam L2 provided by removing the waves of the predetermined wavelengths reduces heat generation in the workpiece, namely, the flexible cable 2, as compared with the direct use of the light beam L1.

The waves of the predetermined wavelengths removed from the light beam L1 by the filter 18 may be those which are absorbed by the workpiece at an absorptance higher than that at which the workpiece absorbs the waves of wavelengths other than those predetermined wavelengths. For example, when the flexible cable 2 is made of a material which absorbs light of wavelengths in the infrared region at an absorptance higher than those at which the flexible cable 2 absorbs light in other wavelength regions, the filter 18 absorbs waves in the infrared region from the light beam L1 and transmits waves in the visible region and ultraviolet region. When the light beam L2 thus provided is used, heat generation in the flexible cable 2 can be suppressed. When the light beam L1 emitted by the light source 12 includes waves of high intensities in the infrared region as shown in FIG. 3, heat generation in the flexible cable 2 can be still more effectively suppressed by removing waves in the infrared region from the light beam L1.

The solder 6, namely, the object of irradiation with the transmitted light beam L2, contains metals, such as tin, silver and copper. Generally, the wavelength dependence of the light absorptances of those metals is low, as compared with that of the polyimide or the like forming the flexible cable 2. More concretely, a principal component of the solder 6 is tin when the solder 6 is a led-free solder. Tin reflects light waves in the near-infrared region and light waves in the visible region at reflectivities around 80% and around 75%, respectively, which proves that the reflectivity of tin at which light incident on tin is reflected does not change greatly with wavelength. Thus the wavelength-dependence of the light absorptance of the solder is insignificant as compared with that of the flexible cable 2. Therefore, the solder 6 can be melted by irradiating the solder 6 with the light provided by removing the waves of the predetermined wavelengths and having the waves of the other wavelength, provided that the light has an intensity at a certain level. Thus the solder 6 can be satisfactorily melted by irradiating the solder 6 with the transmitted light beam L2 not including the waves of the predetermined wavelengths without damaging the flexible cable 2 by using the difference between the solder 6 and the flexible cable 2 in the wavelength dependence of light absorptance.

The construction of the filter 18 is now described. For example, the filter 18 may be a short-pass filter that absorbs waves of wavelengths longer than a predetermined threshold λth and transmits waves of wavelengths shorter than the threshold λth. FIGS. 4(a) and 4(b) show the construction of the filter 18, namely, the short-pass filter, by way of example. The filter 18 is made from a thin metal film of a thickness between about 0.01 and about 0.5 mm. As shown in FIG. 4(a), the filter 18 has a circular shape of a diameter corresponding to the diameter of the light beam L1 collected by the lens unit 16, such as about 32 mm.

FIG. 4(b) is a fragmentary, enlarged view of a part of the surface of the filter 18. As shown in FIG. 4(b), plural apertures 18a are formed in the surface of the filter 18. The area of the plural apertures 18a is about 50% or above of that of the surface of the filter 18. Waves passed through the apertures 18a among those of the light beam L1 are those of the transmitted light beam L2. The filter 18 shown in FIG. 4(b) by way of example has the shape of mesh. The apertures 18a are substantially square openings. The length of the sides of the apertures 18a is dependent on the threshold λth and is, for example, in the range of 0.7 to 190 μm.

For example, when it is desired to remove waves in the infrared region from the light beam L1, the threshold λth is 0.7 and hence the apertures 18a of the filter 18 are 0.7 μm sq. openings. Then waves of wavelengths greater than the size of the apertures 18a are absorbed by the filter 18 of a metal, namely, a conducting material and cannot pass the apertures 18a. Consequently, the filter 18 transmits only waves of wavelengths smaller than 0.7 μm.

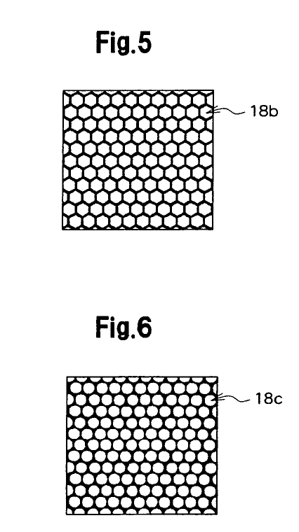

FIG. 4(b) shows the apertures of the filter 18 by way of example. The filter 18 may be provided with apertures of a shape other than that shown in FIG. 4(b). FIGS. 5 and 6 show filters 18 provided with different apertures, respectively, in a fragmentary, enlarged view like the view shown in FIG. 4(b). The filter 18 may be provided with substantially circular apertures 18b of a size corresponding to the threshold λth as shown in FIG. 5. The filter 18 may be provided with hexagonal apertures 18c of a size corresponding to the threshold λth as shown in FIG. 6. The apertures 18c shown in FIG. 6 can give the filter 18 a high rate of hole area, namely, the ratio of the area of apertures to unit area.

The rate of hole area of the filter 18 changes when the number of apertures per unit area is changed. The quantity of the transmitted light beam L2 that passes the filter 18 diminishes when the rate of hole area is reduced. The rate of hole area of the filter 18 may be diminished to use the filter 18 as a neutral-density filter (ND filter). When the filter 18 has the function of a ND filter, the solder 6 can be irradiated with the transmitted light beam L2 provided by removing waves of the predetermined wavelengths from the light beam L1 and reducing the intensity of the light beam L1.

The soldering method in an embodiment is carried out by the above-mentioned soldering device 10. The soldering device 10 removes waves of the predetermined wavelengths from the light beam L1 emitted by the light source 12 by the filter 18 to provide the transmitted light beam L2 and irradiates the solder 6 with the transmitted light beam L2. Thus solder 6 can be melted without damaging the workpiece, such as the flexible cable 2.

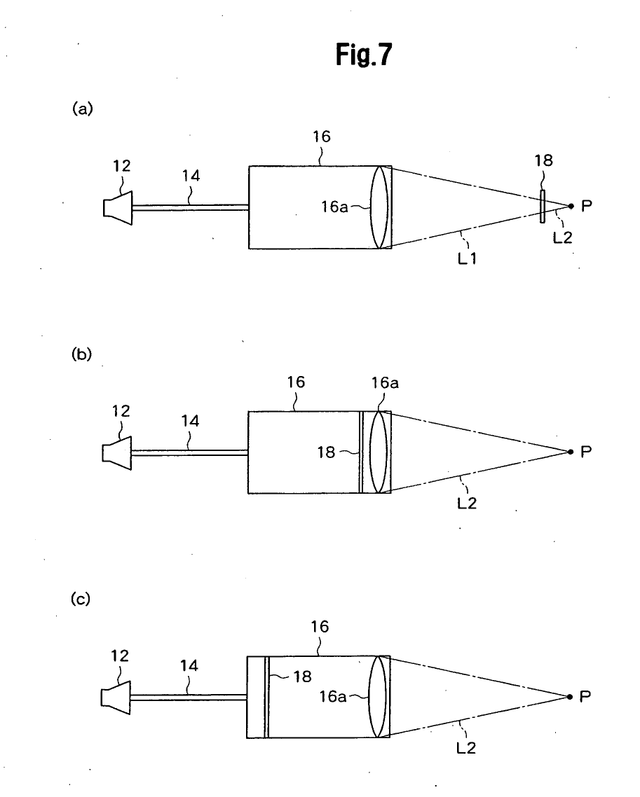

The present invention is not limited to the foregoing specific embodiment. For example, in the foregoing arrangement, the filter 18 is disposed at a position near the lens unit 16 on the optical path between the lens unit 16 and the focal point P. The position of the filter 18 is not limited thereto; the filter 18 may be disposed at any position on the optical path between the light source 12 and the solder 6. More specifically, the filter 18 may be disposed at any one of positions shown in FIGS. 7(a), 7(b) and 7(c).

In FIG. 7(a), a filter 18, like the filter 18 shown in FIG. 2, is disposed between the lens unit 16 and the focal point P. While the filter 18 shown in FIG. 2 is disposed near the lens unit 16, the filter 18 shown in FIG. 7(a) is disposed near the focal point P. When a light beam collected by a condenser lens 16a passes the filter 18, the light beam is diffracted. Therefore, it is difficult to focus the transmitted light beam L2 on the focal point P as compared to a condition in which filter 18 is omitted. The transmitted light beam L2 can be focused on the focal point P by suppressing the effect of diffraction by the filter 18 by disposing the filter 18 at a position apart from the lens unit 16 as shown in FIG. 7(a). When the filter 18 is disposed near the lens unit 16 as shown in FIG. 2, the distance between the filter 18 and the solder 6 is long as compared with that when the filter 18 is disposed as shown in FIG. 7(a). Consequently, heat generation in the filter 18 can be suppressed and soldering work can be facilitated. The filter 18 may be disposed in the lens unit 16 behind the condenser lens 16a, i.e., on the side of the optical fiber 14, as shown in FIGS. 7(b) and 7(c). When the filter 18 is disposed as shown in FIG. 7(b) or 7(c), the filter removes waves of the predetermined wavelengths before the light beam falls on the condenser lens 16a.

In the foregoing description, the filter 18 is a metal filter provided with apertures of the size corresponding to the predetermined threshold λth. A filter other than the filter 18 may be used. For example, two filters like the foregoing filter provided with the apertures of a fixed size may be superposed. When the two filers are superposed with their apertures partly overlapping each other, the effective sizes of the apertures of the superposed filters can be diminished and waves of waveforms shorter than the size of apertures of each of the filters can be removed from the light beam L1. The filter 18 may be an optical thin film capable of absorbing light waves in a predetermined wavelength band.

What is claimed is:

1. A soldering method comprising:
removing component waves of predetermined wavelengths of a light beam emitted by a light source to form a second light beam; and
melting a solder by irradiating the solder with the second light beam obtained by removing the component waves of the predetermined wavelengths from the light beam emitted by the light source.

2. The soldering method according to claim 1, wherein, the predetermined wavelengths are longer than a predetermined threshold.

3. The soldering method according to claim 2, wherein removing component waves of the predetermined wavelengths uses a metal filter provided with apertures of a size corresponding to the predetermined threshold to remove the component waves of the predetermined wavelengths from the first light beam emitted by the light source.

4. The soldering method according to claim 1, wherein the component waves of the predetermined wavelengths are absorbed by a workpiece at a first absorptance higher than a second absorptance at which the workpiece absorbs component waves of wavelengths other than those of the predetermined wavelengths.

5. The soldering method according to claim 4, wherein the predetermined wavelengths are those longer than a predetermined threshold.

6. The soldering method according to claim 5, wherein removing component waves of the predetermined wavelengths uses a metal filter provided with apertures of a size corresponding to the predetermined threshold to remove the component waves of the predetermined wavelengths from the first light beam emitted by the light source.

7. The soldering method according to claim 1 wherein the removing occurs at a position on an optical path between a light source and the solder.

8. The soldering method according to claim 7 wherein the position is near a lens unit on the optical path between the lens unit and a focal point.

9. The soldering method according to claim 1 wherein the removing is performed utilizing a plurality of metal filters having overlapping apertures.

10. The soldering method according to claim 1 wherein the removing is performed by one or more thin films.

11. The soldering method according to claim 1 wherein the removing is performed using a neutral-density (ND) filter.

12. An soldering apparatus comprising:
a light source configured to emit a light beam along an optical path to a solder; and
a filter configured to remove component waves of predetermined wavelengths from the light beam.

13. The soldering method according to claim 12, wherein the predetermined wavelengths are those longer than a predetermined threshold.

14. The soldering apparatus according to claim 13, wherein the filter comprises a metal filter provided with apertures of a size corresponding to the predetermined threshold.

15. The soldering apparatus according to claim 12, wherein the component waves of the predetermined wavelengths are absorbed by a workpiece at a first absorptance higher than a second absorptance at which the workpiece absorbs component waves of wavelengths other than those of the predetermined wavelengths.

16. The soldering apparatus according to claim 12 further comprising a lens unit disposed between the light source and the solder.

17. The soldering apparatus according to claim 16, wherein the filter is positioned between the lens unit and a focal point.

18. The soldering apparatus according to claim 16, wherein the filter is positioned between the light source and lens unit.
